(19) United States
(12) Patent Application Publication
(10) Pub. No.: US 2015/0242488 A1
(43) Pub. Date: Aug. 27, 2015

(54) DATA DISPLAY SYSTEM AND METHOD

(71) Applicant: Codifyd, Inc., Chicago, IL (US)

(72) Inventors: MARK UNAK, Milwaukee, WI (US); Sanjay Agarwal, Naperville, IL (US); Vivek Shivaprabhu, Chicago, IL (US)

(21) Appl. No.: 14/627,634

(22) Filed: Feb. 20, 2015

Related U.S. Application Data
(60) Provisional application No. 61/945,295, filed on Feb. 27, 2014.
(60) Provisional application No. 61/990,893, filed on May 9, 2014.

(51) Int. Cl. G06F 17/30; H04L 29/06; H04L 29/08

(52) U.S. Cl. CPC G06F 17/30598; H04L 67/10; H04L 67/42

(57) ABSTRACT

A method, computer program product, and computing system for receiving a selected product category from a user. The selected product category is associated with a plurality of products available for sale within an online catalog. A master set of attributes is rendered for the plurality of products, wherein the master set of attributes includes a plurality of discrete attributes that are grouped in accordance with attribute type.

### RELATED APPLICATION

This application claims the benefit of U.S. Provisional Application No. 61/942,295 filed on 20 Feb. 2014 and U.S. Provisional Application No. 61/990,893, filed on 9 May 2014, both of which are entitled “Searching System and Method” and the contents of which are all incorporated by reference.

### TECHNICAL FIELD

This disclosure relates to data display systems and, more particularly, to data display system for use with online catalogs.

### BACKGROUND

Online sales are growing exponentially with online resellers (e.g., Amazon.com™) offering for sale a huge assortment of products. Unfortunately, the ability to browse these online catalogs (in a fashion that you would browse within a traditional store) is often difficult, as the related online catalogs are often configured more for searching for a specific product, as opposed to browsing to see what products are offered by the online reseller.

### SUMMARY OF DISCLOSURE

In one implementation, a computer-implemented method is executed on a computer and includes receiving a selected product category from a user. The selected product category is associated with a plurality of products available for sale within an online catalog. A master set of attributes is rendered for the plurality of products, wherein the master set of attributes includes a plurality of discrete attributes that are grouped in accordance with attribute type.

One or more of the following features may be included. A matching quantity is associated with each of the plurality of discrete attributes, wherein each matching quantity defines the quantity of products, chosen from the plurality of products, that include the associated discrete attribute. The matching quantity may be adjusted for each of the plurality of discrete attributes based, at least in part, upon one or more attribute selections made by the user. A first attribute selection may be received from the user, wherein the first attribute selection is chosen from the plurality of discrete attributes included within the master set of attributes. The master set of attributes may be filtered based, at least in part, upon the first attribute selection, thus defining a first filtered set of attributes. The first filtered set of attributes may be rendered. A second attribute selection may be received from the user, wherein the second attribute selection is chosen from the plurality of discrete attributes included within the first filtered set of attributes. The first filtered set of attributes may be filtered based, at least in part, upon the second attribute selection, thus defining a second filtered set of attributes, The second filtered set of attributes may be rendered.

In another implementation, a computer program product resides on a computer readable medium that has a plurality of instructions stored on it. When executed by a processor, the instructions cause the processor to perform operations including receiving a selected product category from a user. The selected product category is associated with a plurality of products available for sale within an online catalog. A master set of attributes is rendered for the plurality of products, wherein the master set of attributes includes a plurality of discrete attributes that are grouped in accordance with attribute type.

One or more of the following features may be included. A matching quantity is associated with each of the plurality of discrete attributes, wherein each matching quantity defines the quantity of products, chosen from the plurality of products, that include the associated discrete attribute. The matching quantity may be adjusted for each of the plurality of discrete attributes based, at least in part, upon one or more attribute selections made by the user. A first attribute selection may be received from the user, wherein the first attribute selection is chosen from the plurality of discrete attributes included within the master set of attributes. The master set of attributes may be filtered based, at least in part, upon the first attribute selection, thus defining a first filtered set of attributes. The first filtered set of attributes may be rendered. A second attribute selection may be received from the user, wherein the second attribute selection is chosen from the plurality of discrete attributes included within the first filtered set of attributes. The first filtered set of attributes may be filtered based, at least in part, upon the second attribute selection, thus defining a second filtered set of attributes, The second filtered set of attributes may be rendered.

In another implementation, a computing system includes at least one processor and at least one memory architecture coupled with the at least one processor, wherein the computing system is configured to perform operations including receiving a selected product category from a user. The selected product category is associated with a plurality of products available for sale within an online catalog. A master set of attributes is rendered for the plurality of products, wherein the master set of attributes includes a plurality of discrete attributes that are grouped in accordance with attribute type.

One or more of the following features may be included. A matching quantity is associated with each of the plurality of discrete attributes, wherein each matching quantity defines the quantity of products, chosen from the plurality of products, that include the associated discrete attribute. The matching quantity may be adjusted for each of the plurality of discrete attributes based, at least in part, upon one or more attribute selections made by the user. A first attribute selection may be received from the user, wherein the first attribute selection is chosen from the plurality of discrete attributes included within the master set of attributes. The master set of attributes may be filtered based, at least in part, upon the first attribute selection, thus defining a first filtered set of attributes. The first filtered set of attributes may be rendered. A second attribute selection may be received from the user, wherein the second attribute selection is chosen from the plurality of discrete attributes included within the first filtered set of attributes. The first filtered set of attributes may be filtered based, at least in part, upon the second attribute selection, thus defining a second filtered set of attributes, The second filtered set of attributes may be rendered.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a data display process coupled to a distributed computing network;

FIG. 2 is a flow chart of one implementation of the data display process of FIG. 1;

FIG. 3 is a diagrammatic view of various database records utilized by the data display process of FIG. 1;

FIG. 4 is a flow chart of another implementation of the data display process of FIG. 1;

FIGS. 5A-5F are diagrammatic views of menus rendered by the data display process of FIG. 1;

FIG. 6 is a flow chart of another implementation of the data display process of FIG. 1; and

FIGS. 7A-7D are diagrammatic views of product availability screens rendered by the data display process of FIG. 1.

Like reference symbols in the various drawings indicate like elements.

### DETAILED DESCRIPTION OF THE PREFERRED EMBODIMENTS

### System Overview:

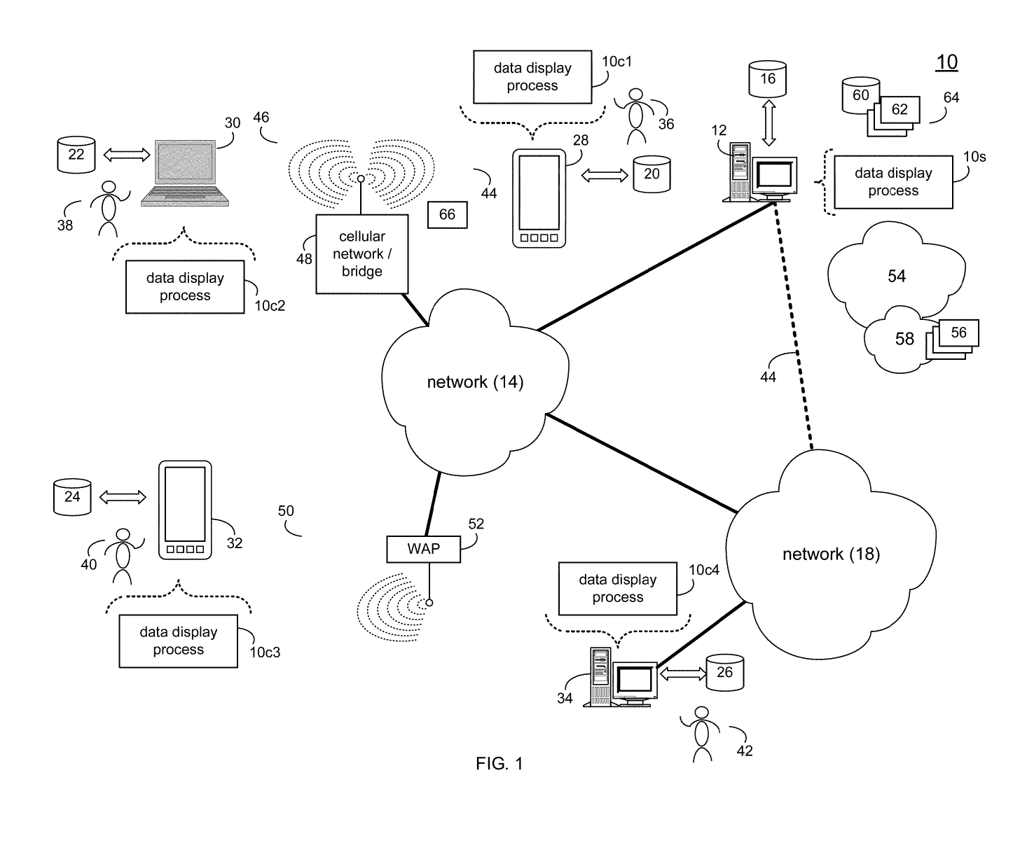

In FIG. 1, there is shown data display process 10. As will be discussed below in greater detail, data display process 10 may be configured to display to a user the various products that are available for purchase via a online catalog.

Data display process 10 may be implemented as a server-side process, a client-side process, or a hybrid server-side/client-side process. For example, data display process 10 may be implemented as a purely server-side process via data display process 10s. Alternatively, data display process 10 may be implemented as a purely client-side process via one or more of data display process 10c1, data display process 10c2, data display process 10c3, and data display process 10c4. Alternatively still, data display process 10 may be implemented as a hybrid server-side/client-side process via data display process 10s in combination with one or more of data display process 10c1, data display process 10c2, data display process 10c3, and data display process 10c4. Accordingly, data display process 10 as used in this disclosure may include any combination of data display process 10s, data display process 10c1, data display process 10c2, data display process 10c3, and data display process 10c4.

Data display process 10s may be a server application and may reside on and may be executed by computing device 12, which may be connected to network 14 (e.g., the Internet or a local area network). Examples of computing device 12 may include, but are not limited to: a personal computer, a laptop computer, a tablet computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of data display process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of data display processes 10c1, 10c2, 10c3, 10c4 may include but are not limited to a web browser, a game console user interface, a social network user interface, or a specialized application. The instruction sets and subroutines of data display processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a tablet computer (not shown), a notebook computer (not shown), a server computer (not shown), a smart television (not shown), a gaming console (not shown), and a dedicated network device (not shown). Client electronic devices 28, 30, 32, 34 may each execute an operating system.

Users 36, 38, 40, 42 may access data display process 10 directly through network 14 or through secondary network 18. Further, data display process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Data Display Process:

Assume for illustrative purposes that reseller business 54 is an internet-based retailer (such as an Amazon.com™) that offers for sale a plurality of products 56 via online catalog 58 (e.g., a retail website) that may be purchased by users (e.g., users 36, 38, 40, 42). Further, assume that database 60 is utilized by data display process 10 to organize the plurality of products 56 offered via online catalog 58.

Query Processing:

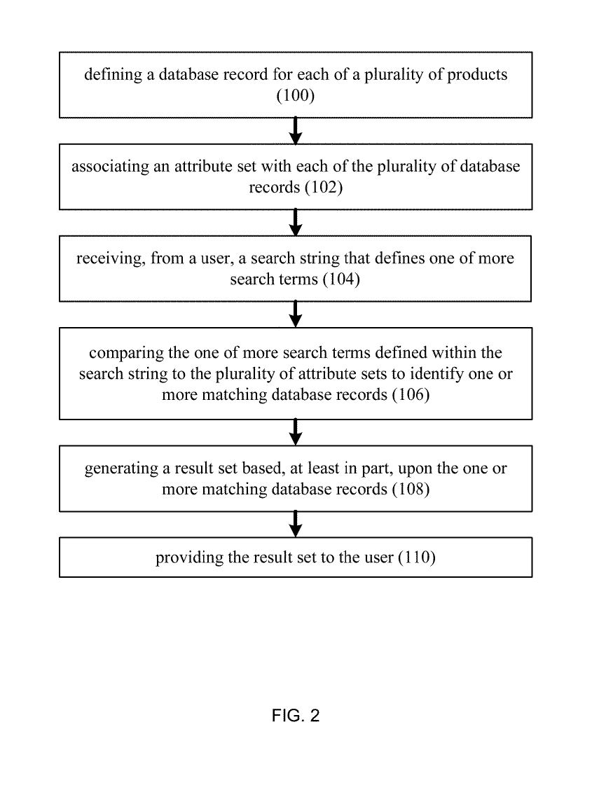

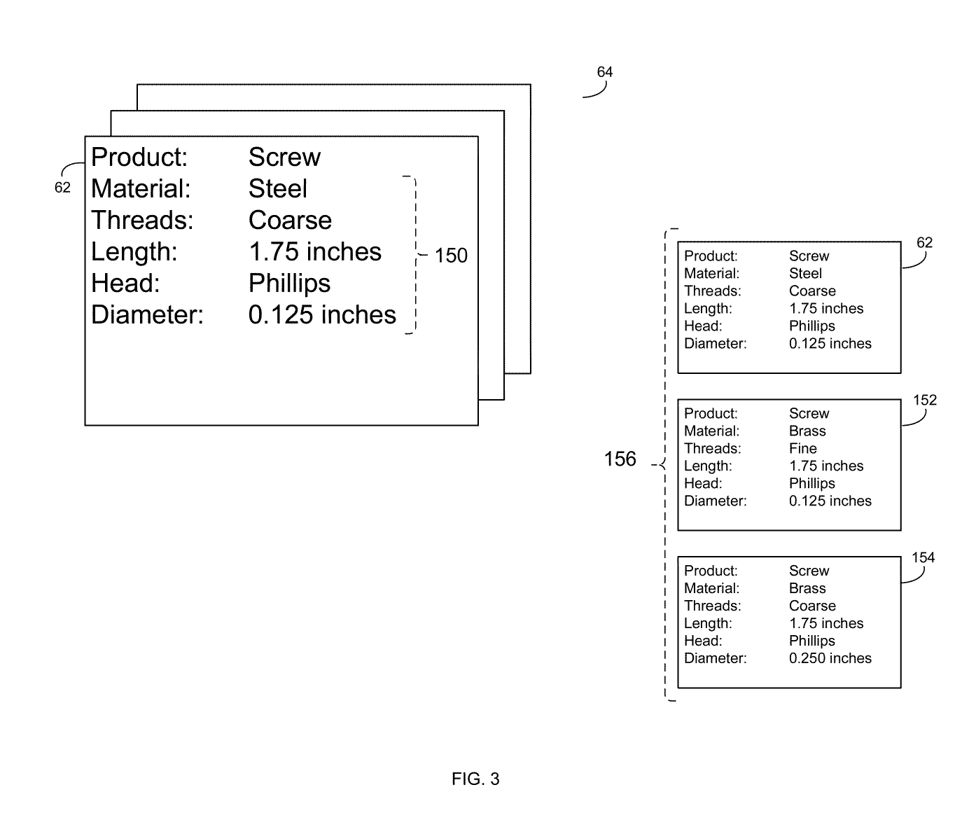

Referring also to FIGS. 2-3, data display process 10 may define 100 a database record (e.g., database record 62) for each of plurality of products 56 available for sale within online catalog 58, thus defining plurality of database records 64.

Data display process 10 may associate 102 an attribute set (e.g., attribute set 150) with each of plurality of database records 64, thus defining a plurality of attribute sets. Each of these attribute sets (e.g., attribute set 150) may define one or more features of the product associated with the related database record. For example, these features may include but are not limited to one or more physical attributes of the product associated with (in this example) database record 62. Additionally/alternatively, these features may include but are not limited to one or more capabilities of the product associated with (in this example) database record 62.

For example, if database record 62 concerns a screw (i.e., a product included within plurality of products 56 that is available via online catalog 58), attribute set 150 associated database record 62 may define the various features of this particular screw (e.g., what material the screw is made of, what type of threads the screw has, what type of head the screw has, the length of the screw, and the diameter of the shank of the screw).

Assume for illustrative purposes that user 36 visits online catalog 58 (e.g., a retail website) to potentially purchase (for this example) packages of screws. Accordingly and upon visiting online catalog 58, user 36 may construct a search string for the product that they are looking for (namely screws). Accordingly, assume that user 36 enters (via e.g., data display process 10c1) the search string “1¾” Phillips screws” and submits search string 66 to data display process 10.

Data display process 10 may receive 104, from user 36, search string 66 (e.g., “1¾” Phillips screws”) that defines one of more search terms (e.g., “1¾” & Phillips & screws”) and may compare 106 the search terms (1¾” & Phillips & screws) defined within search string 66 to the plurality of attribute sets (i.e., each attribute set that is defined for each database record within plurality of database records 64) to identify one or more matching database records, chosen from plurality of database records 64.

For example and upon comparing 106 the search terms (1¾″ & Phillips & screws) defined within search string 66 to the plurality of attribute sets, data display process 10 may identify three matching database records (namely database records 62, 152, 154), all of which are screws having a Phillips head that are 1¾″ in length.

Data display process 10 may generate 108 a result set (e.g., result set 156) based, at least in part, upon the one or more matching database records (namely database records 62, 152, 154), wherein result set 156 may define one or more products that are associated with the one or more matching database records (e.g., database records 62, 152, 154). In this particular example, result set 156 is shown to define three screws, all of which have a Phillips head and are 1¾″ in length. Specifically, database record 62 identifies a 1¾″ Phillips head screw that is constructed of steel, has coarse threads, and a 0.125″ diameter shank; database record 152 identifies a 1¾″ Phillips head screw that is constructed of brass, has fine threads, and a 0.125″ diameter shank; and database record 154 identifies a 1¾“Phillips head screw that is constructed of brass, has coarse threads, and a 0.250” diameter shank.

Data display process 10 may provide 110 the result set (e.g., result set 156) to the user (e.g., user 36), thus enabling user 36 to compare the various products defined within database records 62, 152, 154 and purchase one or more of the same.

Multi-Level Menuing:

While data display process 10 is described above as allowing users to search for various products offered by reseller business 54, data display process 10 may be configured to allow users to browse plurality of products 56 available from reseller business 54 via online catalog 58.

Specifically, data display process 10 may be configured to render a product tree in a hierarchical fashion that allows user 36 to browse online catalog 58. Specifically, this hierarchical product tree may be configured to allow user 36 to explore the types of products available within a specific category/subcategory, without ever losing sight of their position within the product tree.

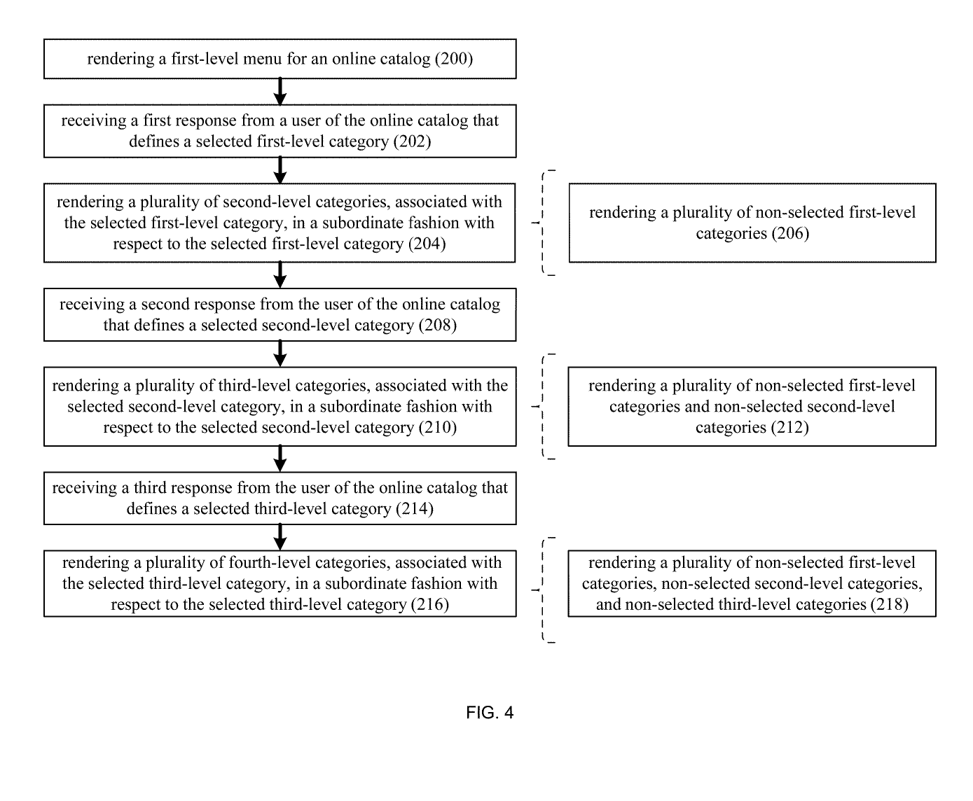

Accordingly and referring also to FIGS. 4 & 5A, data display process 10 may render 200 first-level menu 250 for online catalog 58, wherein first-level menu 250 defines a plurality of first-level categories 252 (e.g., Abrasives; Adhesives, Sealants & Tape; Bearings; Chemicals, Lubricants & Equipment; Cutting Tools; Electric Motors & Controls; Facility Maintenance; Hand & Power Tools; Hose & Fittings; Hydraulics; Janitorial; Linear Motion; Material Handling; Mechanical Power Transmission; Pneumatics; Process Pumps; Safety; and Seals, Gaskets & Accessories). Plurality of first-level categories 252 may define a plurality of product categories of online catalog 58. Assume for illustrative purposes that user 36 selects “Safety” using onscreen pointer 254 (that is controllable via e.g., a mouse, a touchpad or a touch screen).

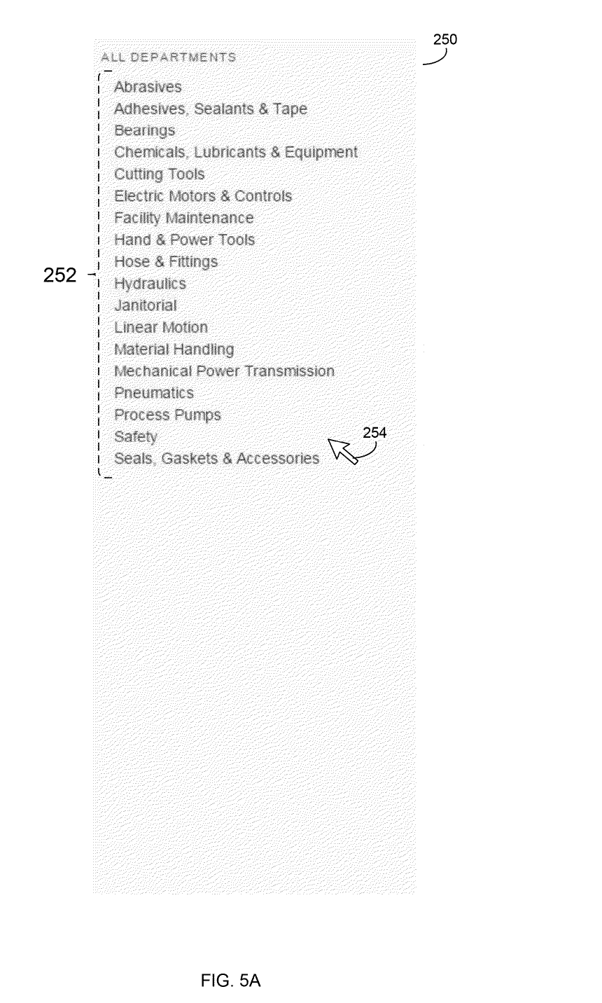

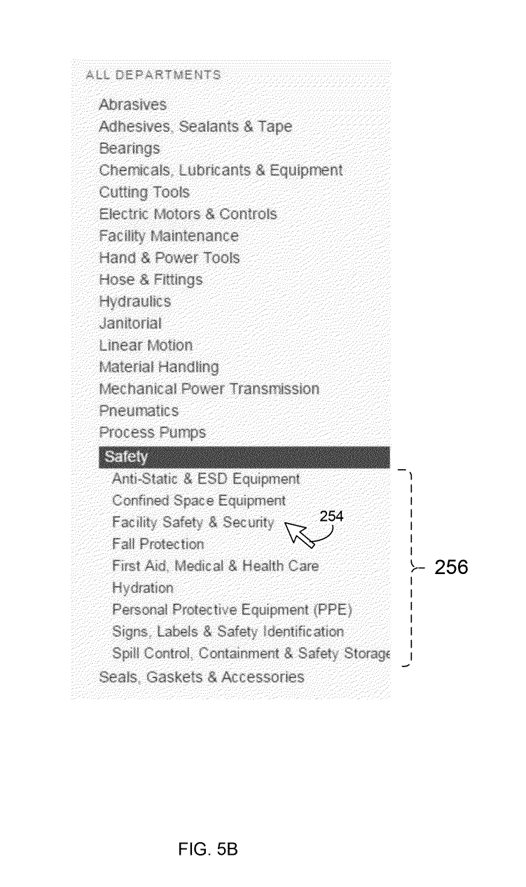

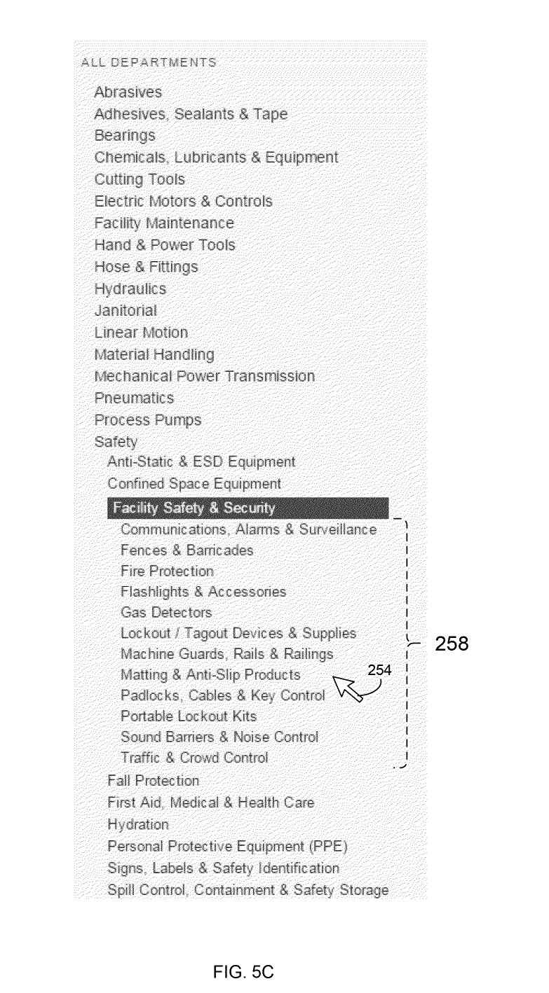

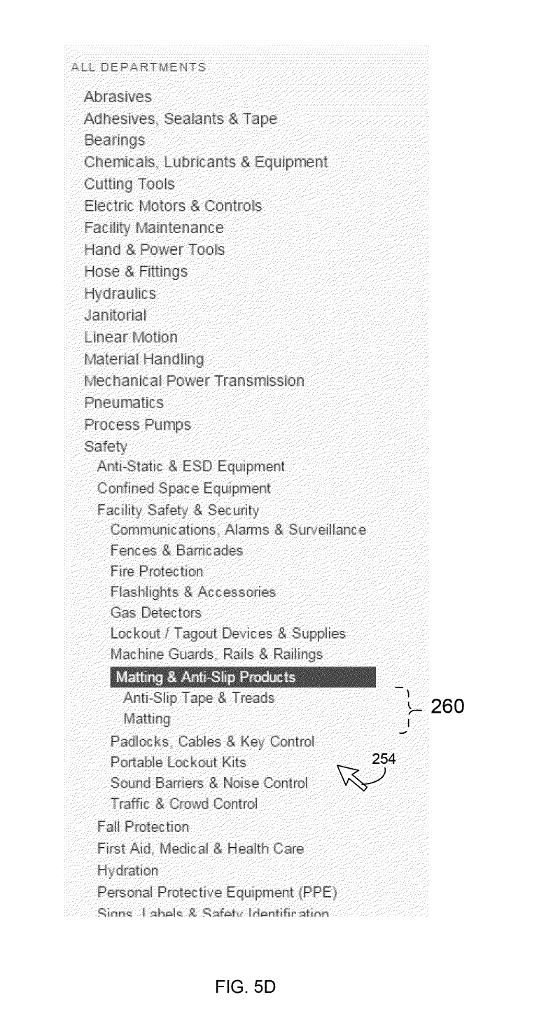

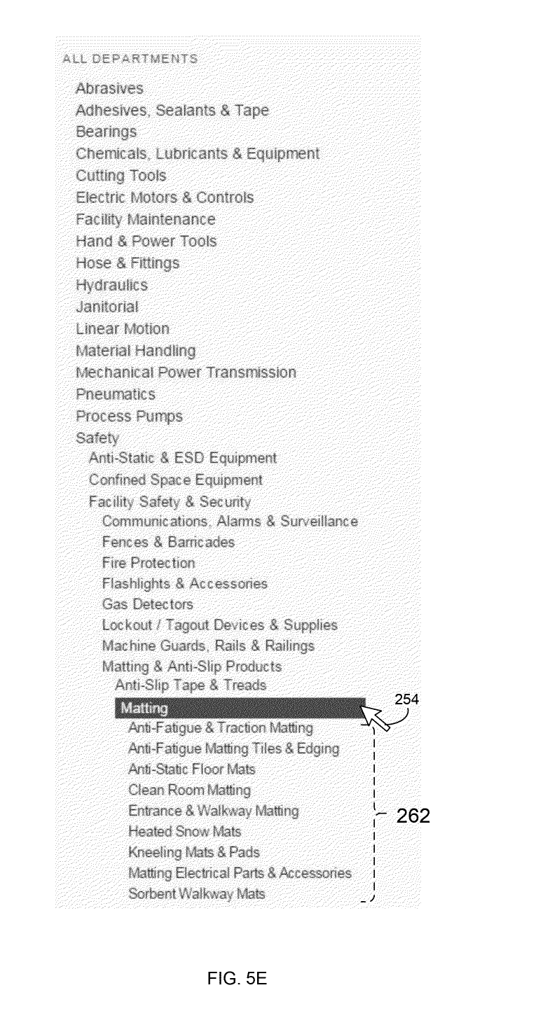

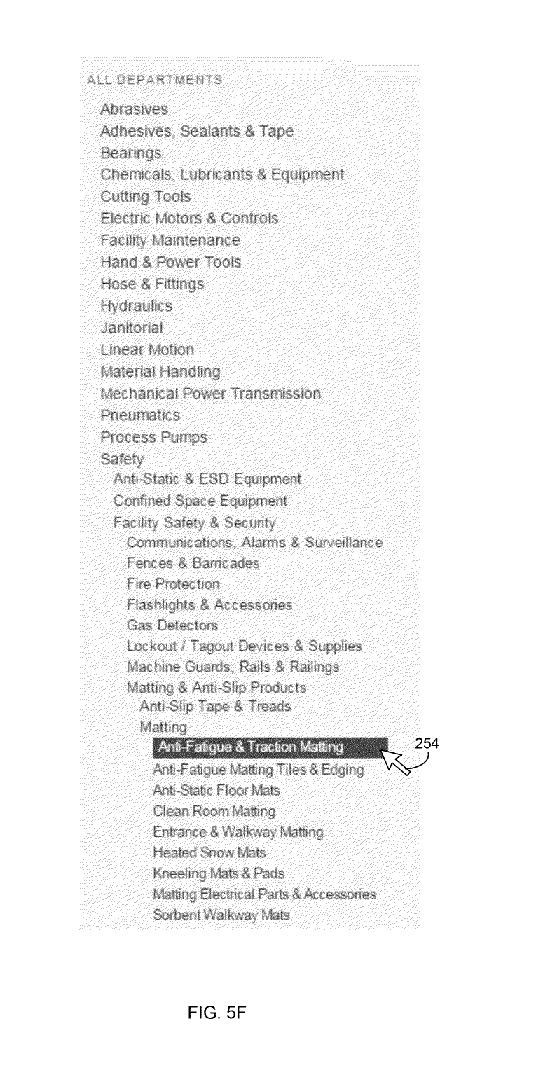

Referring also to FIG. 5B, data display process 10 may receive 202 a first response (e.g., the selection of “Safety”) from user 36 of online catalog 58 that defines a selected first-level category (e.g., “Safety”), chosen from the plurality of first-level categories (e.g., Abrasives; Adhesives, Sealants & Tape; Bearings; Chemicals, Lubricants & Equipment; Cutting Tools; Electric Motors & Controls; Facility Maintenance; Hand & Power Tools; Hose & Fittings; Hydraulics; Janitorial; Linear Motion; Material Handling; Mechanical Power Transmission; Pneumatics; Process Pumps; Safety; and Seals, Gaskets & Accessories).

In response to receiving 202 the first response (e.g., the selection of “Safety” by user 36), data display process 10 may render 204 a plurality of second-level categories 256 (e.g., Anti-Static & ESD Equipment; Confined Space Equipment; Facility Safety & Security; Fall Protection; First Aid, Medical & Healthcare; Hydration; Personal Protective Equipment (PPE); Signs, Labels & Safety Identification; and Spill Control, Containment & Safety Storage) that are associated with the selected first-level category (e.g., “Safety”) in a subordinate fashion (e.g., indented) with respect to the selected first-level category (e.g., “Safety”).

When rendering 204 the plurality of second-level categories 256, data display process 10 may also render 206 a plurality of non-selected first-level categories (i.e., first-level categories other than “Safety”), thus allowing user 36 to easily jump back up to a higher level. Assume for illustrative purposes that user 36 selects “Facility Safety & Security” using onscreen pointer 254.

Referring also to FIG. 5C, data display process 10 may receive 208 a second response (e.g., the selection of “Facility Safety & Security”) from user 36 of online catalog 58 that defines a selected second-level category (e.g., “Facility Safety & Security”), chosen from the plurality of second-level categories (e.g., Anti-Static & ESD Equipment; Confined Space Equipment; Facility Safety & Security; Fall Protection; First Aid, Medical & Healthcare; Hydration; Personal Protective Equipment (PPE); Signs, Labels & Safety Identification; and Spill Control, Containment & Safety Storage).

In response to receiving 208 the second response (e.g., the selection of “Facility Safety & Security” by user 36), data display process 10 may render 210 a plurality of third-level categories 258 (e.g., Communications, Alarms & Surveillance; Fences & Barricades; Fire Protection; Flashlights & Accessories; Gas Detectors; Lockout/Tagout Devices & Supplies; Machine Guards, Rails & Railings; Matting & Anti-Slip Products; Padlocks, Cables & Key Control; Portable Lockout Kits; Sound Barriers & Noise Control; and Traffic & Crowd Control) that are associated with the selected second-level category (e.g., “Facility Safety & Security”) in a subordinate fashion (e.g., indented) with respect to the selected second-level category (e.g., “Facility Safety & Security”).

When rendering 210 the plurality of third-level categories 258, data display process 10 may also render 212 a plurality of non-selected first-level categories (i.e., first-level categories other than “Safety”) and non-selected second-level categories (i.e., second-level categories other than “Facility Safety & Security”), thus allowing user 36 to easily jump back up to a higher level. Assume for illustrative purposes that user 36 selects “Matting & Anti-Slip Products” using onscreen pointer 254.

Referring also to FIG. 5D, data display process 10 may receive 214 a third response (e.g., the selection of “Matting & Anti-Slip Products”) from user 36 of online catalog 58 that defines a selected third-level category (e.g., “Matting & Anti-Slip Products”), chosen from the plurality of third-level categories (e.g., Communications, Alarms & Surveillance; Fences & Barricades; Fire Protection; Flashlights & Accessories; Gas Detectors; Lockout/Tagout Devices & Supplies; Machine Guards, Rails & Railings; Matting & Anti-Slip Products; Padlocks, Cables & Key Control; Portable Lockout Kits; Sound Barriers & Noise Control; and Traffic & Crowd Control).

In response to receiving 214 the third response (e.g., the selection of “Matting & Anti-Slip Products” by user 36), data display process 10 may render 216 a plurality of fourth-level categories 258 (e.g., Anti-Slip Tape and Treads; and Matting) that are associated with the selected third-level category (e.g., the selection of “Matting & Anti-Slip Products” by user 36) in a subordinate fashion (e.g., indented) with respect to the selected third-level category (e.g., “Matting & Anti-Slip Products”).

When rendering 216 the plurality of fourth-level categories 260, data display process 10 may render 218 a plurality of non-selected first-level categories (i.e., first-level categories other than “Safety”), non-selected second-level categories (i.e., second-level categories other than “Facility Safety & Security”) and non-selected third-level categories (i.e., third-level categories other than “Matting & Anti-Slip Products”), thus allowing user 36 to easily jump back up to a higher level.

The process of receiving responses from the user and rendering additional subcategories may continue until all subcategories are exhausted. For example, FIG. 5E illustrates plurality of fifth level categories 262 rendered by data display process 10 in response to user 36 selecting fourth-level category “Matting”. Further, FIG. 5F illustrates user 36 selecting fifth-level category “Anti-Fatigue & Traction matting”.

Dynamic Result Sets:

As discussed above, the process of receiving responses from user 36 and rendering additional subcategories may continue until all subcategories are exhausted. Once all subcategories are exhausted, the user (e.g., user 36) may be presented with a graphical representation of the products available within the selected subcategory (in this example, “Anti-Fatigue & Traction Matting”). Assume for the following example that there are no product subcategories under “Anti-Fatigue & Traction Matting”, resulting in data display process 10 considering “Anti-Fatigue & Traction Matting” to be a selected product category.

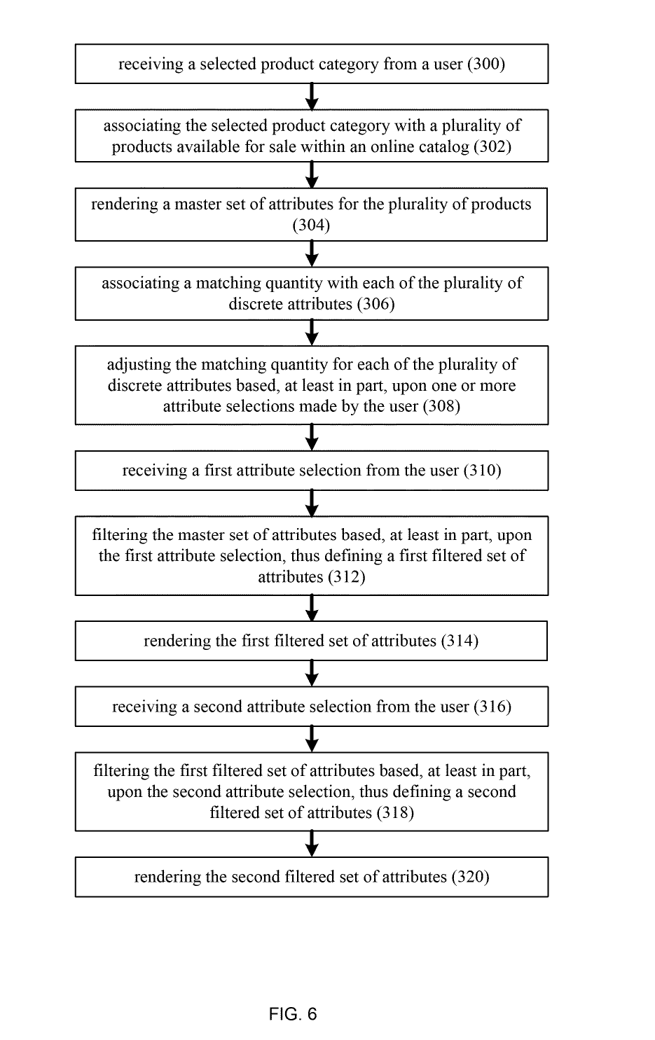

Referring also to FIG. 6, data display process 10 may receive 300 a selected product category (e.g., “Anti-Fatigue & Traction Matting”) from user 36 and data display process 10 may associate 302 the selected product category (e.g., “Anti-Fatigue & Traction Matting”) with a plurality of products available for sale within online catalog 58.

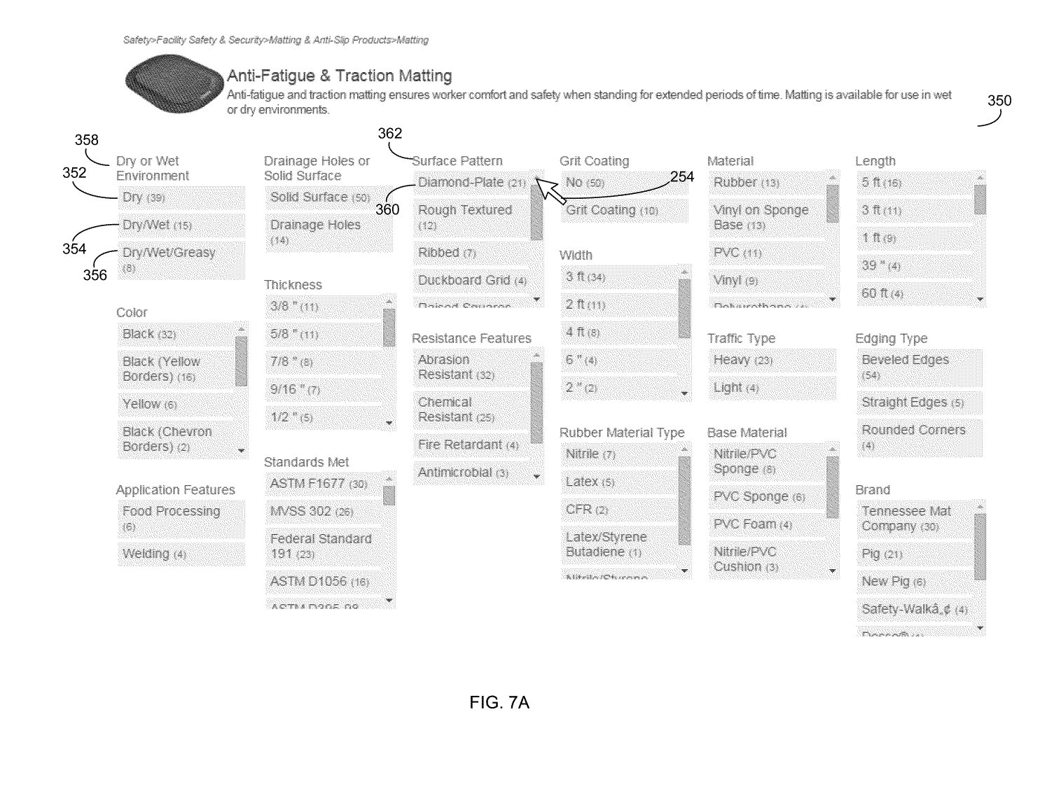

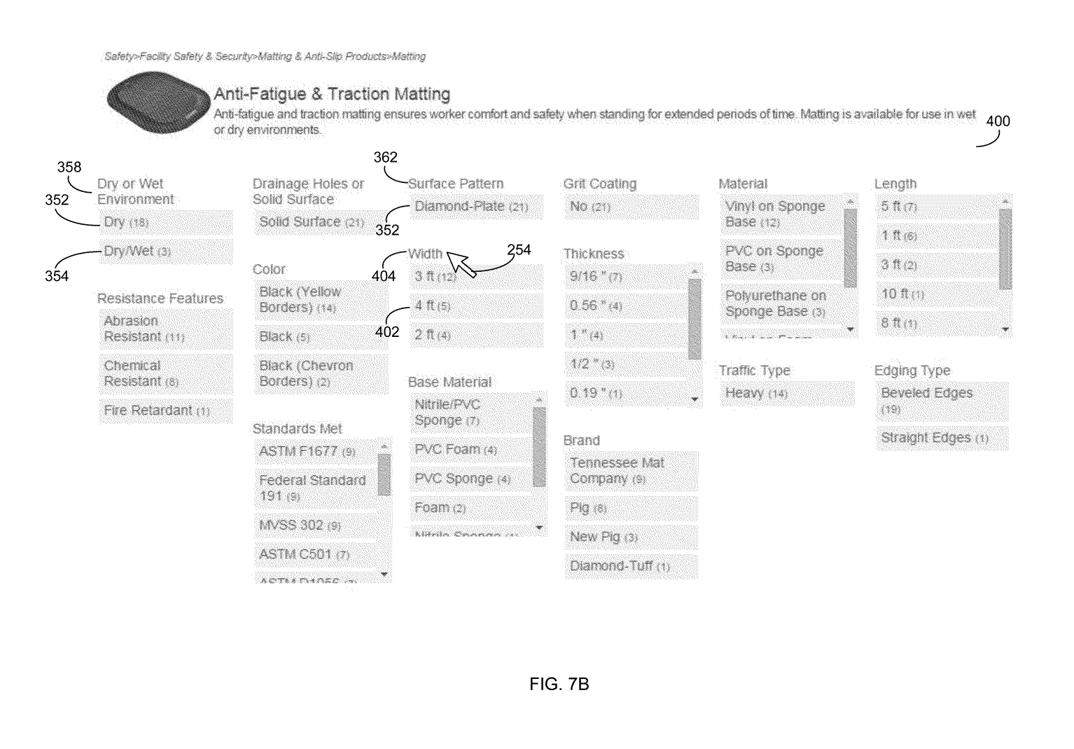

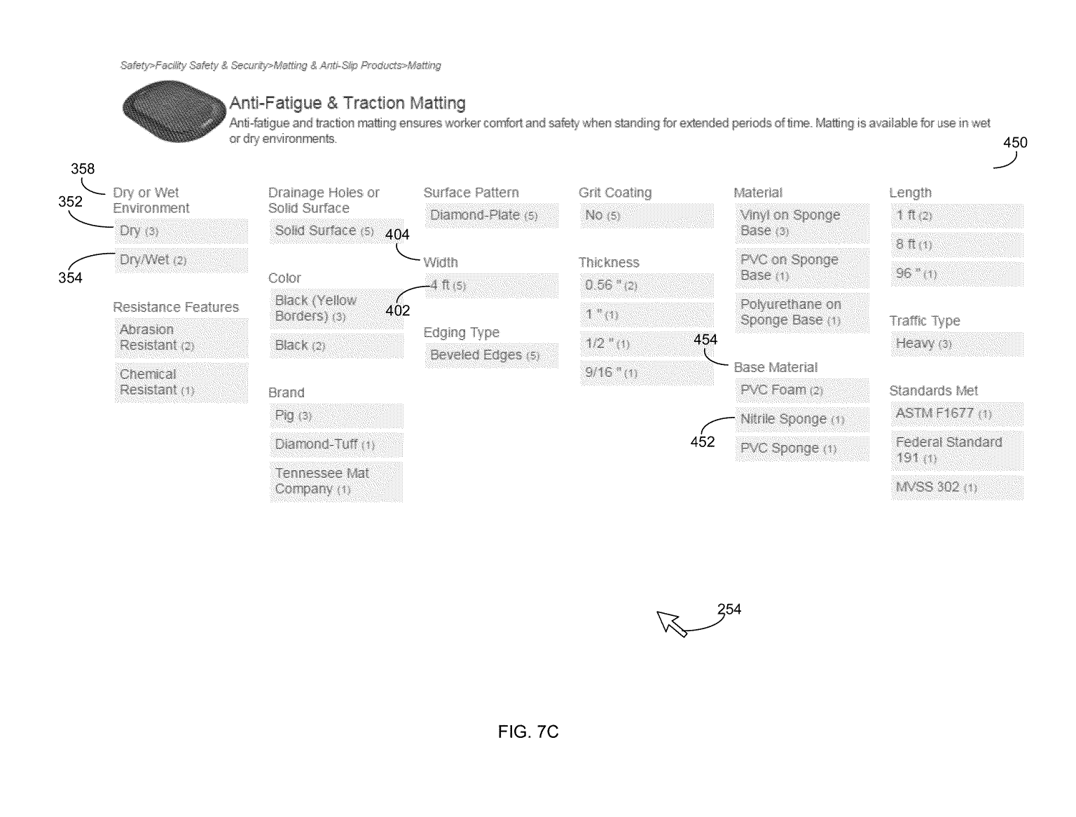

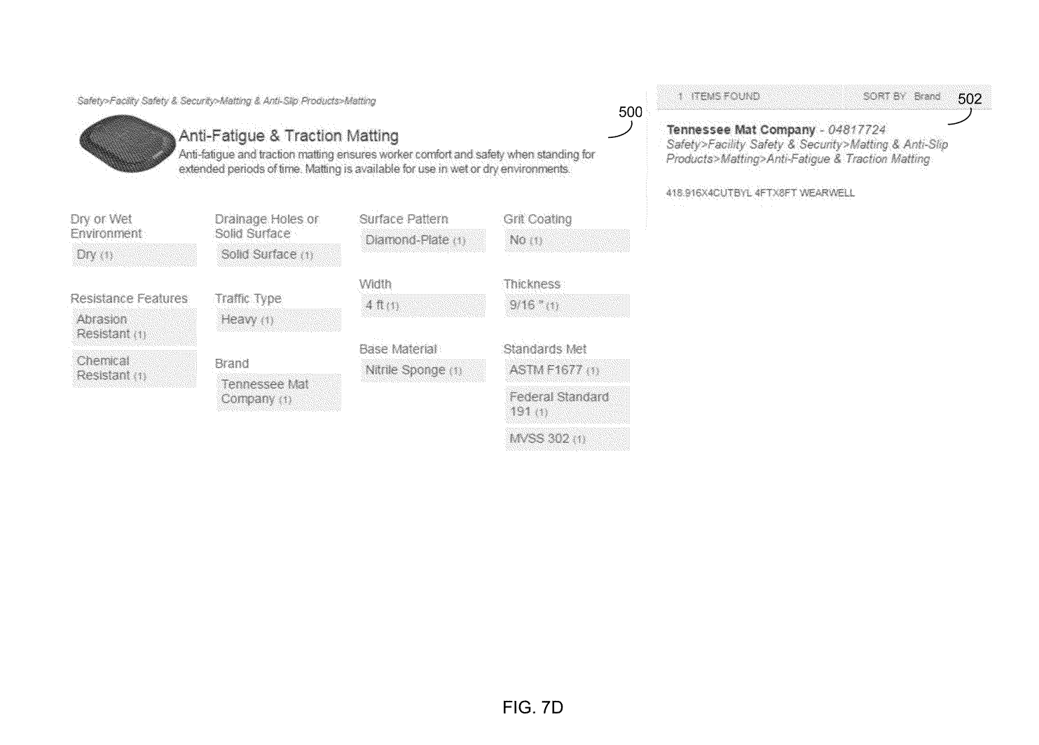

Referring also to FIG. 7A, data display process 10 may render 304 master set of attributes 350 for the plurality of products available within the selected product category (e.g., “Anti-Fatigue & Traction Matting”). Master set of attributes 350 may include a plurality of discrete attributes (e.g., discrete attributes 352, 354, 356) that are grouped in accordance with attribute type (e.g., attribute type 358).

As discussed above and when defining a product for inclusion within online catalog 58, data display process 10 may associate an attribute set with the database record that defines each product. These attribute sets may define one or more features of the related product, such as one or more physical attributes of the product and/or one or more capabilities of the product.

Accordingly and with respect to “Anti-Fatigue & Traction Matting”, these attributes may be grouped into various attribute types (e.g., Wet or Dry Environment; Color; Application Features; Drainage Holes or Solid Surface; Thickness; Standards Met; Surface Pattern; Resistance Features; Grit Coating; Width; Rubber Material Type; Material; Traffic Type; Base Material; Length; Edging Type; and Brand).

Under each of these various attribute types (e.g., attribute type 358), the options (i.e., the discrete attributes) concerning that specific attribute type may be defined. For example and under attribute type “Wet or Dry Environment” 358, three discrete attributes may be defined, namely the “Dry” discrete attribute 352, the “Dry/Wet” discrete attribute 354, and the “Dry/Wet/Greasy” discrete attribute 356.

Data display process 10 may associate 306 a matching quantity with each of the plurality of discrete attributes (e.g., discrete attributes 352, 354, 356), wherein these matching quantities may define the quantity of products (chosen from plurality of products 56) that includes the associated discrete attribute. For example, 39 products include “Dry” discrete attribute 352 and are designed for use in dry environments; 15 products include “Dry/Wet” discrete attribute 354 and are designed for use in either dry or wet environments; and 8 products include “Dry/Wet/Greasy” discrete attribute 356 and are designed for use in either dry or wet or greasy environments.

As will be discussed below in greater detail, data display process 10 may adjust 308 the above-described matching quantity for each of the plurality of discrete attributes based, at least in part, upon one or more attribute selections made by the user (e.g., user 36).

Assume for illustrative purposes that user 36 is interested in a floor mat that has a diamond plate surface. Accordingly, user 36 may select (using onscreen pointer 254) “Diamond-Plate” discrete attribute 360 under “Surface Pattern” attribute type 362. Data display process 10 may receive 310 a first attribute selection (e.g., the selection of “Diamond-Plate”) from user 36, wherein this first attribute selection may be chosen from the plurality of discrete attributes included within master set of attributes 350.

Referring also to FIG. 7B and in response to receiving 310 the first attribute selection (e.g., the selection of “Diamond-Plate” from user 36), data display process 10 may filter 312 master set of attributes 350 based, at least in part, upon the first attribute selection (e.g., “Diamond-Plate”), thus defining first filtered set of attributes 400 that may be rendered 314 by data display process 10.

Note that under “Surface Pattern” attribute type 362, the only discrete attribute included is “Diamond-Plate” discrete attribute 360, as any floor mat without a diamond plate surface pattern was filtered 312 from the result set by data display process 10. Further note that the above-described matching quantities are also adjusted based upon filtering 312 of the result set by data display process 10. For example and with respect to “Wet or Dry Environment” attribute type 358, only 18 products (down from 39) now include “Dry” discrete attribute 352 and are designed for use in dry environments; only 3 products (down from 15) now include “Dry/Wet” discrete attribute 354 and are designed for use in either dry or wet environments; and 0 products (down from 8) include “Dry/Wet/Greasy” discrete attribute 356 and are designed for use in either dry or wet or greasy environments.

Assume for illustrative purposes that user 36 is interested in a floor mat that is 4 feet wide. Accordingly, user 36 may select (using onscreen pointer 254) “4 ft” discrete attribute 402 under “Width” attribute type 404. Data display process 10 may receive 316 a second attribute selection (e.g., the selection of “4 ft”) from user 36, wherein this second attribute selection may be chosen from the plurality of discrete attributes included within first filtered set of attributes 400.

Referring also to FIG. 7C and in response to receiving 316 the second attribute selection (e.g., the selection of “4 ft” from user 36), data display process 10 may filter 318 first filtered set of attributes 400 based, at least in part, upon the second attribute selection (e.g., “4 ft”), thus defining second filtered set of attributes 450 that may be rendered 320 by data display process 10.

Note that under “Width” attribute type 404, the only discrete attribute included is “4 ft” discrete attribute 402, as any floor mat that was not four feet wide was filtered 318 from the result set by data display process 10. Further note that matching quantities again are adjusted based upon filtering 318 of the result set by data display process 10. For example and with respect to “Wet or Dry Environment” attribute type 358, only 3 products (down from 18) now include “Dry” discrete attribute 352 and are designed for use in dry environments; and only 2 products (down from 3) now include “Dry/Wet” discrete attribute 354 and are designed for use in either dry or wet environments.

Assume for illustrative purposes that user 36 is interested in a floor mat that has a base material of “Nitrile Sponge” (for which the above-described matching quantity is defined as “1”). Accordingly, user 36 may select (using onscreen pointer 254) “Nitrile Sponge” discrete attribute 452 under “Base Material” attribute type 454. Data display process 10 may receive this attribute selection (e.g., the selection of “Nitrile Sponge”) from user 36, wherein this attribute selection may be chosen from the plurality of discrete attributes included within second filtered set of attributes 450.

Referring also to FIG. 7D and in response to receiving this attribute selection (e.g., the selection of “Nitrile Sponge” from user 36), data display process 10 may filter second filtered set of attributes 450 based, at least in part, upon this attribute selection (e.g., “Nitrile Sponge”), thus defining third filtered set of attributes 500 that may be rendered by data display process 10. In this particular example, third filtered set of attributes 500 is shown to include only one product (available via online catalog 58) and includes a link to specific information concerning this product (which is manufactured by Tennessee Mat Company).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computer, the computer-implemented method comprising:
receiving a selected product category from a user;
associating the selected product category with a plurality of products available for sale within an online catalog; and
rendering a master set of attributes for the plurality of products, wherein the master set of attributes includes a plurality of discrete attributes that are grouped in accordance with attribute type.

2. The computer-implemented method of claim 1 further comprising:
associating a matching quantity with each of the plurality of discrete attributes, wherein each matching quantity defines the quantity of products, chosen from the plurality of products, that includes the associated discrete attribute.

3. The computer-implemented method of claim 2 further comprising:
adjusting the matching quantity for each of the plurality of discrete attributes based, at least in part, upon one or more attribute selections made by the user.

4. The computer-implemented method of claim 1 further comprising:
receiving a first attribute selection from the user, wherein the first attribute selection is chosen from the plurality of discrete attributes included within the master set of attributes.

5. The computer-implemented method of claim 4 further comprising:
filtering the master set of attributes based, at least in part, upon the first attribute selection, thus defining a first filtered set of attributes; and
rendering the first filtered set of attributes.

6. The computer-implemented method of claim 5 further comprising:
receiving a second attribute selection from the user, wherein the second attribute selection is chosen from the plurality of discrete attributes included within the first filtered set of attributes.

7. The computer-implemented method of claim 6 further comprising:
filtering the first filtered set of attributes based, at least in part, upon the second attribute selection, thus defining a second filtered set of attributes; and
rendering the second filtered set of attributes.

8. A computer program product residing on a computer readable medium having a plurality of instructions stored thereon which, when executed by a processor, cause the processor to perform operations comprising:
receiving a selected product category from a user;
associating the selected product category with a plurality of products available for sale within an online catalog; and
rendering a master set of attributes for the plurality of products, wherein the master set of attributes includes a plurality of discrete attributes that are grouped in accordance with attribute type.

9. The computer program product of claim 8 further comprising instructions for:
associating a matching quantity with each of the plurality of discrete attributes, wherein each matching quantity defines the quantity of products, chosen from the plurality of products, that includes the associated discrete attribute.

10. The computer program product of claim 9 further comprising instructions for:
adjusting the matching quantity for each of the plurality of discrete attributes based, at least in part, upon one or more attribute selections made by the user.

11. The computer program product of claim 8 further comprising instructions for:
receiving a first attribute selection from the user, wherein the first attribute selection is chosen from the plurality of discrete attributes included within the master set of attributes.

12. The computer program product of claim 11 further comprising instructions for:
filtering the master set of attributes based, at least in part, upon the first attribute selection, thus defining a first filtered set of attributes; and
rendering the first filtered set of attributes.

13. The computer program product of claim 12 further comprising instructions for:
receiving a second attribute selection from the user, wherein the second attribute selection is chosen from the plurality of discrete attributes included within the first filtered set of attributes.

14. The computer program product of claim 13 further comprising instructions for:
filtering the first filtered set of attributes based, at least in part, upon the second attribute selection, thus defining a second filtered set of attributes; and
rendering the second filtered set of attributes.

15. A computing system including a processor and memory configured to perform operations comprising:
receiving a selected product category from a user;
associating the selected product category with a plurality of products available for sale within an online catalog; and
rendering a master set of attributes for the plurality of products, wherein the master set of attributes includes a plurality of discrete attributes that are grouped in accordance with attribute type.

16. The computing system of claim 15 further configured to perform operations comprising:
associating a matching quantity with each of the plurality of discrete attributes, wherein each matching quantity defines the quantity of products, chosen from the plurality of products, that includes the associated discrete attribute.

17. The computing system of claim 14 further configured to perform operations comprising:
adjusting the matching quantity for each of the plurality of discrete attributes based, at least in part, upon one or more attribute selections made by the user.

18. The computing system of claim 1 further configured to perform operations comprising:
receiving a first attribute selection from the user, wherein the first attribute selection is chosen from the plurality of discrete attributes included within the master set of attributes.

19. The computing system of claim 18 further configured to perform operations comprising:
filtering the master set of attributes based, at least in part, upon the first attribute selection, thus defining a first filtered set of attributes; and
rendering the first filtered set of attributes.

20. The computing system of claim 19 further configured to perform operations comprising:
receiving a second attribute selection from the user, wherein the second attribute selection is chosen from the plurality of discrete attributes included within the first filtered set of attributes.

21. The computing system of claim 20 further configured to perform operations comprising:
filtering the first filtered set of attributes based, at least in part, upon the second attribute selection, thus defining a second filtered set of attributes; and
rendering the second filtered set of attributes.
